(19) United States
(12) Patent Application Publication
(10) Pub. No.: US 2012/0007988 A1
(43) Pub. Date: Jan. 12, 2012

(54) IMAGING DEVICE, DISPLAY-IMAGING DEVICE, AND ELECTRONIC EQUIPMENT

(75) Inventors: Masanobu Ikeda, Aichi (JP); Ryoichi Ito, Aichi (JP); Keiichiro Ishihara, Aichi (JP); Yoshikazu Sasaki, Aichi (JP)

(73) Assignee: SONY CORPORATION, Tokyo (JP)

(21) Appl. No.: 13/176,262

(22) Filed: Jul. 5, 2011

(30) Foreign Application Priority Data
Jul. 9, 2010 (JP) 2010-156893

(51) Int. Cl. H04N 5/335; H04N 5/33

(52) U.S. Cl. 348/164; 348/294; 348/E05.091; 348/E05.09

(57) ABSTRACT

Disclosed herein is an imaging device including: a plurality of photodetecting elements arranged on a substrate, each having a first semiconductor layer for the channel region; and a plurality of driving elements arranged on the substrate, each having a second semiconductor layer for the channel region, wherein the first and second semiconductor layers each are a crystallized semiconductor layer, the first and second semiconductor layers each are approximately equal in thickness and impurity concentration, and the first and second semiconductor layers each have an average trap level density no higher than 2.0×10¹⁷ (cm⁻³) which is an average value of trap level density obtained by the FE (Field Effect) method within the range of intrinsic Fermi level Ei ±0.2 eV.

### CROSS REFERENCES TO RELATED APPLICATIONS

The present application claims priority to Japanese Priority Patent Application JP 2010-156893 filed in the Japan Patent Office on Jul. 9, 2010, the entire content of which is hereby incorporated by reference.

### BACKGROUND

The present application relates to an imaging device and a display-imaging device, each having photodetecting elements and driving elements, and an electronic equipment provided with the display-imaging device.

Display devices, such as liquid crystal display devices and organic EL display devices, have recently been refined by addition of photodetecting elements or photodetectors (such as photodiodes) which detect and control the brightness and contrast of images displayed thereon. The photodiodes function in concert with driving elements (such as TFT (thin film transistor)) and display elements mounted on the display device. See Japanese Patent Laid-open Nos. 2009-93154 (Patent Document 1) and 2009-177127 (Patent Document 2).

Among the photodiodes is known a PIN-type photodiode in plane form. The PIN-type photodiode includes three layers p-type, i-type, and n-type semiconductor (or polycrystalline silicon) sequentially arranged on a substrate.

### SUMMARY

The above-mentioned display-imaging device (such as optical touch panel), which has the photodetecting elements and driving elements formed on the same substrate, requires that both elements have equally high characteristic values. Unfortunately, the existing display-imaging device has the disadvantage that the photodiode (photodetecting element) needs to have a thin semiconductor layer (channel layer) so that the TFT (driving element) has limited leakage current when it is off. The thin semiconductor layer (for photoelectric conversion) transmits a large portion of incident light entering the photodetecting element, and this results in an insufficient photodetecting sensitivity (or a low amount of detected light).

According to Patent Document 1 mentioned above, this problem is tackled by forming a first active layer (channel layer) for the driving element and a second active layer for the photodetecting element, both on the same underlying layer of the substrate, such that the latter has a higher light absorptivity than the former. To be more specific, the second active layer for the photodetecting element is made thicker than the first active layer for the driving element.

The disadvantage of making the second active layer thicker than the first active layer is that they cannot be formed between the driving element and the photodetecting element by the same step. This makes the fabricating process complex.

On the other hand, according to Patent Document 2 mentioned above, the foregoing problem is tackled by forming the PIN-type photodiode (photodetecting element) such that its intermediate semiconductor region is doped with p-type impurity in low concentrations and a positive voltage is applied to the control electrode. This arrangement permits the electron-hole pairs to separate immediately after they have occurred in the depletion region in the intermediate layer, thereby readily generating photoelectric current. Therefore, even if the channel length (L length) of the intermediate semiconductor region is increased, photo current will not be saturated, so that enhanced light detection sensitivity can be achieved.

This technique, however, has the disadvantage of requiring that the intermediate semiconductor region (channel region) of the photodetecting element be doped with impurity in higher concentrations than the channel region of the driving element. In other words, the concentration of impurity (or carrier) in the channel layer (semiconductor layer) should differ between the photodetecting element and the driving element. This needs new steps and makes the fabricating process complex.

As mentioned above, the existing technique involves difficulties in allowing both the photodetecting element and the driving element, which are formed on the same substrate, to have high characteristic values, without requiring complex fabricating steps. Thus a remedy for this has been sought after.

The present application has been completed in view of the foregoing. It is an aim to provide an imaging device, a display-imaging device, and an electronic equipment that can be produced without necessity for complex fabricating process. They have photo-detecting elements and driving elements both of which have high characteristic values.

The embodiments are directed to an imaging device which has a plurality of photodetecting elements arranged on a substrate, each having a first semiconductor layer for the channel region and a plurality of driving elements arranged on the substrate, each having a second semiconductor layer for the channel region, wherein the first and second semiconductor layers each are a crystallized semiconductor layer, the first and second semiconductor layers each are approximately equal in thickness and impurity concentration, and the first and second semiconductor layers each have an average trap level density no higher than 2.0×10¹⁷ (cm⁻³) which is an average value of trap level density obtained by the FE (Field Effect) method within the range of intrinsic Fermi level Ei ±0.2 eV.

The embodiments are directed also to a display-imaging device which has a plurality of display elements, the photodetecting elements, and the driving elements, which are arranged on a substrate.

The embodiments are directed also to an electronic equipment which is provided with the display-imaging device according to the embodiments.

According to the embodiments, in the imaging device, display-imaging device, and electronic equipment, the photodetecting element and the driving element have respectively a first semiconductor layer and a second semiconductor layer which are approximately equal to each other in thickness and impurity concentration. This structure permits the two kinds of semiconductor layers to be easily formed by the same process. In other words, the two kinds of semiconductor layers do not need to be different in thickness and impurity concentration. Moreover, the first and second semiconductor layers have an average trap level density no higher than 2.0×10¹⁷ (cm⁻³), so that both the photodetecting element and the driving element have high characteristic values (such as the amount of light detected and the ratio of on-off currents of transistor, respectively).

According to the embodiments, in the imaging device, display-imaging device, and electronic equipment, the photodetecting element and the driving element have respectively a first semiconductor layer and a second semiconductor layer which are approximately equal to each other in thickness and impurity concentration. Moreover, the first and second semiconductor layers have an average trap level density no higher than 2.0×10¹⁷ (cm⁻³). Consequently, these two kinds of semiconductor layers can be easily formed by the same process, and both the photodetecting element and the driving element can have high characteristic values without the necessity for complicated fabricating process.

Additional features and advantages are described herein, and will be apparent from the following Detailed Description and the figures.

### BRIEF DESCRIPTION OF THE FIGURES

FIG. 1 is a schematic sectional view showing the structure of the imaging device pertaining to one embodiment;

FIG. 2 is a circuit diagram for the structure of the pixel in the imaging device shown in FIG. 1;

FIG. 3 is a schematic diagram illustrating the trap level density;

FIG. 4 is a diagram for characteristic properties illustrating the trap level density;

FIG. 5 is a flow sheet showing the steps for production of the imaging device pertaining to the embodiment;

FIGS. 6A to 6I are sectional views showing each of the steps shown in FIG. 5;

FIG. 7 a flow sheet showing the steps for production of the imaging device pertaining to Comparative Example 2;

FIGS. 8A to 8C are sectional views showing each of the steps shown in FIG. 7;

FIGS. 9A to 9B are diagrams for characteristic properties illustrating the average trap level density in Comparative Examples and Examples;

FIG. 10 is a diagram illustrating the relation between the average trap level density and the characteristic properties of the photodetecting element and TFT element in Examples;

FIG. 11 is a diagram illustrating the relation between the average trap level density and the characteristic properties of the photodetecting element and TFT element in Examples;

FIG. 12 is a diagram illustrating the relation between the L length and the characteristic properties of visible light detection in the photodetecting element pertaining to Examples and Comparative Examples;

FIG. 13 is a diagram illustrating the relation between the L length and the characteristic properties of infrared light detection in the photodetecting element pertaining to Examples and Comparative Examples;

FIG. 14 is a schematic sectional view showing an example of the structure of the display-imaging device to which is applied the imaging device shown in FIG. 1;

FIG. 15 is a schematic sectional view showing another example of the structure of the display-imaging device to which is applied the imaging device shown in FIG. 1;

FIG. 16 is a perspective view showing the external appearance of an example (1) of the application of the display-imaging device;

FIGS. 17A and 17B are perspective views showing respectively the front appearance and the rear appearance of an example (2) of the application of the display-imaging device;

FIG. 18 is a perspective view showing the external appearance of an example (3) of application;

FIG. 19 is a perspective view showing the external appearance of an example (4) of application; and

FIGS. 20A to 20G are front view (FIG. 20A), side view (FIG. 20B), front view (FIG. 20C) in closed state, left side view (FIG. 20D), right side view (FIG. 20E), top view (FIG. 20F), and bottom view (FIG. 20G) of an example (5) of application.

### DETAILED DESCRIPTION

Embodiments of the present application will be described below in detail with reference to the drawings.

1. Embodiments (for the imaging device having photodetecting elements and driving elements whose semiconductor layer (channel layer) has an average trap level density which is established within a prescribed range)

2. Examples of application (to the display-imaging device and the electronic equipment)

### Embodiments

### Sectional Structure of the Imaging Device 1

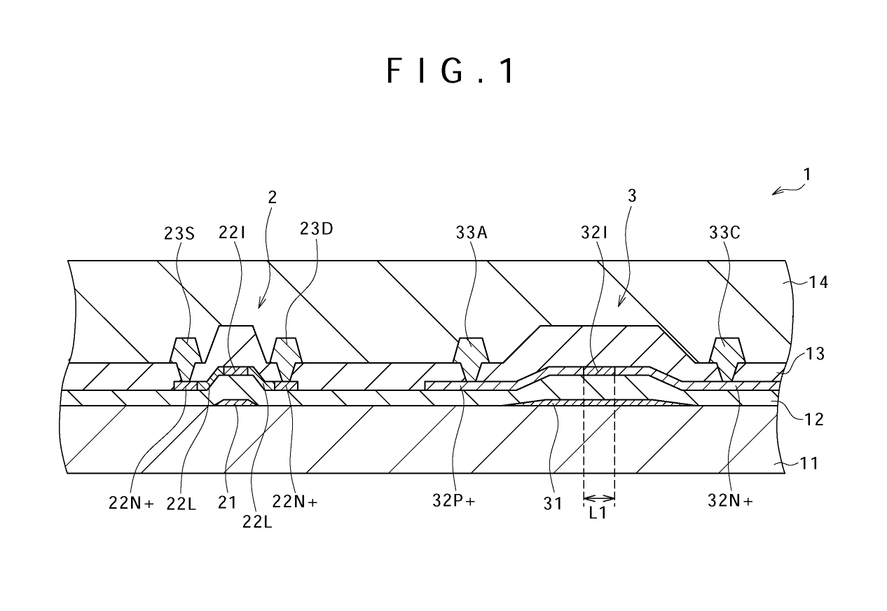

FIG. 1 shows an example of the sectional structure of the imaging device 1 pertaining to one embodiment. The imaging device 1 has a plurality of imaging pixels (or the pixel 10 mentioned later). The imaging device 1 is composed of the substrate 11, the gate insulating film 12, the interlayer insulating film 13, and the planarizing film 14, which are sequentially arranged on top of the other. It also has a plurality of TFT elements 2 (driving elements) and a plurality of photodetecting elements 3 (light-receiving elements) on the substrate 11 thereof.

The substrate 11 is formed from a transparent (light-transmitting) material, such as glass, plastics, quartz, and aluminum oxide.

The gate insulating film 12 is formed on the substrate 11, with the gate electrodes 21 and 31 (mentioned later) interposed between them. On the gate insulating film 12 are formed the N+ layer 22N+, the LDD (Lightly Doped Drain) layer 22L, the P+ layer 32P+, the N+ layer 32N+, and the I layer 32I, which are mentioned later. The interlayer insulating film 13 is formed on the gate insulating film 12, the N+ layer 22N+, the LDD layer 22L, the P+ layer 32P+, the N+ layer 32N, and the I layer 32I. The planarizing film 14 is formed on the interlayer insulating film 13 mentioned above, and the source electrode 23S, the drain electrode 23D, the anode electrode 33A, and the cathode electrode 33C, which are mentioned later. The gate insulating film 12, the interlayer insulating film 13, and the planarizing film 14, which are mentioned above, are formed from an insulating material such as silicon nitride (SiN) and silicon oxide (SiO), or organic resin film. Each of them may be formed from a single material or composed of more than one layer of different materials.

(TFT Element 2)

The TFT element 2 is an element to drive the photodetecting element 3 (upon light detection and light reception), mentioned later. The illustrated one is a TFT of MOS (Metal-Oxide-Semiconductor) type. It is composed of the gate electrode 21, the gate insulating film 12 (mentioned above), the paired N+ layers 22N+, the paired LDD layers 22L, the I layer 22I (the second semiconductor layer), the source electrode 23S, and the drain electrode 23D.

The gate electrode 21 is formed in the region opposite to the I layer 22I, with the gate insulating film 12 interposed between them.

The paired N⁺ layers N⁺ are formed from an n-type semiconductor heavily doped with n-type impurity, such as phosphorous (P). One of them is electrically connected to the source electrode 23S and the other of them is electrically connected to the drain electrode 23D. This n-type semiconductor is a crystallized (or crystalline) semiconductor which permits high carrier (electron) mobility. It includes, for example, polysilicon (p-Si) and microcrystalline silicon (μ-Si). The N⁺ layer 22N⁺ of polycrystalline silicon can be formed by forming a film from amorphous silicon (a-Si) by CVD (Chemical Vapor Deposition) and then annealing the thus formed film by irradiation with a laser beam (such as excimer laser), as mentioned later.

The paired LDD layers 22L are formed from n-type semiconductor lightly doped with n-type impurity (such as P). Each of them is formed between each of the paired N⁺ layers 22N⁺ and the I layer 22I. The LDD layers 22L are also formed from crystallized (crystalline) semiconductor, like the N⁺ layers 22N⁺.

The I layer 22I is formed from i-type semiconductor doped only with an impurity for adjustment of Vth (threshold value). It is intended to form the channel region. Like the N⁺ layer 22N⁺, it is also formed from crystallized (crystalline) semiconductor. It has a thickness and an impurity concentration which are almost identical with those of the I layer 32I in the light-detecting element 3, mentioned later. In other words, the I layer 22I and the I layer 32I are almost identical with each other in their thickness and impurity concentration. To be more specific, the thickness is about 30 to 60 nm, and the amount of impurity is 3×10¹¹ to 8×10¹¹ (atm/cm²). In other words, these layers are formed by the same process as explained later.

The source electrode 23S and the drain electrode 23D each are a single layer of aluminum (Al) or a composite layer of Ti/Al/Ti or Mo/Al/Mo.

Light-Detecting Element 3

The light-detecting element 3 is intended to detect light incident on the I layer 32I (the first semiconductor layer) which functions as a photodetector (light receiver). The illustrated one is a photodiode of PIN-type. This light-detecting element 3 is composed of the gate electrode 31, the gate insulating film 12, the P+ layer 32P+, the N+ layer 32N+, the I layer 32I, the anode electrode 33A, and the cathode electrode 33C (which were mentioned above except for the first one).

The gate electrode 31 is formed in the region opposite to the I layer 32I, with the gate insulating film 12 interposed between them. Like the gate electrode 21 mentioned above, it is formed from an electrically conductive material such as Mo.

The P+ layer 32P+ is formed from a p-type semiconductor which is heavily doped with p-type impurity such as boron (B). It is electrically connected to the anode electrode 33A. The p-type semiconductor is a crystallized (crystalline) semiconductor, so that it has a high carrier (hole) mobility.

As in the N+ layer 22N+ mentioned above, the N+ layer 32N+ is formed from a n-type semiconductor which is heavily doped with n-type impurity (such as P). It is electrically connected to the cathode electrode 33C. The n-type semiconductor is a crystallized (crystalline) semiconductor, so that it has a high carrier (electron) mobility.

The I layer 32I is formed from i-type semiconductor doped only with impurity for Vth adjustment, like the I layer 22I mentioned above. It has the channel region formed therein. The I layer 32I is also formed from crystallized (crystalline) semiconductor like the N+ layer 32N+. This I layer 32I is almost identical in thickness and impurity concentration with the I layer 22I in the TFT element 2. The I layer 32I should preferably have the channel length L1 (shown in FIG. 1), which is no shorter than 4.0 μm and no longer than 40 μm. (A detailed description will be given later.)

The anode electrode 33A and the cathode electrode 33C each are a single layer of aluminum (Al) or a composite layer of Ti/Al/Ti or Mo/Al/Mo, as in the case of the source electrode 23S and the drain electrode 23D mentioned above.

Structure of Circuit for Pixel 10

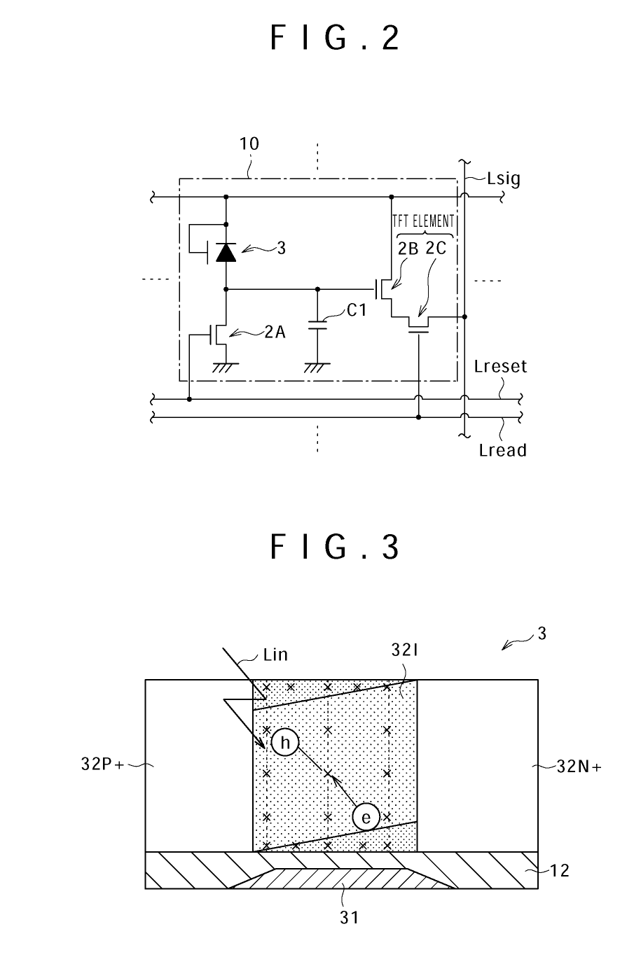

The pixel 10 in the imaging device 1 has a circuit constructed as mentioned below with reference FIG. 2. FIG. 2 is a diagram illustrating a typical example the structure of the circuit for the pixel 10. Each pixel 10 has the photodetecting element 3 (mentioned above), the three TFT elements 2A, 2B, and 2C (as the TFT elements 2 mentioned above), and the capacitance element C1. In addition, each pixel 10 is connected to the power line VDD, the signal line L_{sig} (to which is sent the photodetection signals obtained by the photodetecting element 3), the reset line Lᵣₑₛₑₜ (for reset actions), and the read line L_{read} (to read or output the photodetection signals).

The photodetecting element 3 has its gate and cathode connected to the power line VDD and also has its anode connected to the drain of the TFT element 2A, one terminal of the capacitance element C1, and the gate of the TFT element 2B. The TFT element 2A has its gate connected to the reset line Lᵣₑₛₑₜ and its source connected to the ground. The capacitance element C1 has its another terminal connected also to the ground. The TFT element 2B has its source connected to the power line VDD and its drain connected to the drain of the TFT element 2C. The TFT element 2C has its gate connected to the read line L_{read} and its source connected to the signal line L_{sig}.

Each pixel 10 with the circuit constructed as mentioned above accomplishes photodetection in the following way. First, the TFT element 2A becomes turned on as soon as it receives a reset signal from the reset line Lᵣₑₛₑₜ, and, as the result, one terminal of the capacitance element C1 is initialized (or reset) to the ground potential. Subsequently, upon incidence of light, the photodetecting element 3 generates photoelectric current, and a charge proportional to the magnitude of photoelectric current is accumulated in the capacitance element C1. The TFT element 2B becomes turned on in response to the read signal from the read line L_{read}, so that the photodetection signal (or light-receiving signal) is sent out (or read out). In other words, the TFT element 2B, which constitutes the source-follower circuit, amplifies the signal (in response to the charge accumulated in the capacitance element C1), and the thus amplified signal is sent out to the signal line L_{sig} through the TFT element 2C.

Trap Level Density

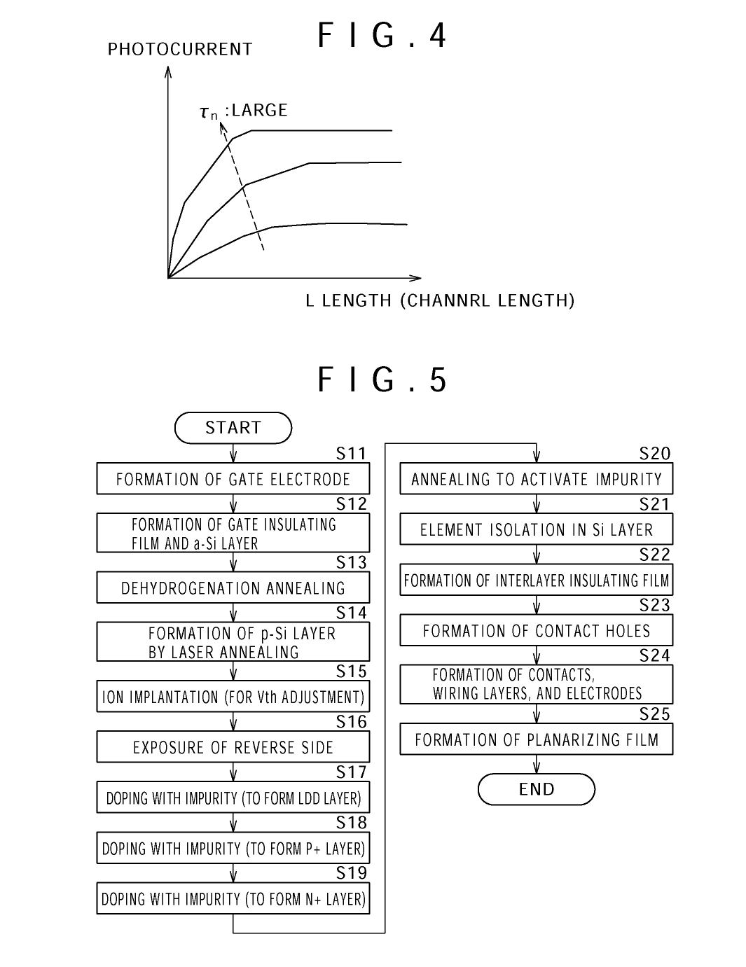

The imaging device 1 has as one of its features the trap level density in the I layer 22I of the TFT element 2 and the I layer 32I (channel region) of the photodetecting element 3. The trap level density is a parameter which is described below with reference to FIGS. 3 and 4.

Any semiconductor usually has some sort of defects which destroy the regular periodicity of the crystal lattice and introduce the energy level (trap level) into the forbidden gap in the same way as the donor or acceptor impurity does. The energy level sets off transition across the conduction band and the valence band. The probability of transition of the carriers depends on the magnitude of the step, and hence the trap level facilitates such transition and drastically affects the life of carriers. How many of specific trap levels are there is defined by the trap level density. In other words, the trap level density is regarded as a parameter associated with the life of carriers in the channel region. The life of carriers is inversely proportional to the trap level density and the photoelectric current is proportional to the life of carriers (as discussed in detail later).

In the embodiment, the I layer 22I and the I layer 32I are specified according to the average trap level density, which is an average of the trap level densities obtained by the FE (Field Effect) method within the intrinsic Fermi level Ei±0.2 eV. The reason for this is explained in detail below. First, the life of carriers varies depending on not only the dose of impurities but also the state of the insulating film in contact with the semiconductor film and the film quality (including the state of crystals) that results from the step of laser irradiation. It is believed that the parameter that definitely specifies the life of carriers is the average trap level density.

According to the FE method, the trap level density can be expressed by the function of activation energy Ea and hence it follows that the trap level density can be obtained by calculating the activation energy Ea, as discussed in detail later. Moreover, any electronic device made of polycrystalline silicon usually has two kinds of trap level density: the grain boundary trap level density which exists at the grain boundary of polycrystalline silicon and the interfacial trap level density which exists at the interface between the polycrystalline silicon layer and the gate insulating film. The FE method makes it possible to obtain the trap level in terms of a sum of the grain boundary trap level and the interfacial trap level.

The trap level density as a parameter characterized as mentioned above can be obtained typically from the following formulas (1) to (6). The formulas (1) to (5) represent respectively the activating energy Ea in the I layer 22I and the I layer 32I (channel region), the Poisson's equation, the surface electric field, the surface potential, and the charge in film. Incidentally, the activating energy Ea can be obtained by measuring the change in current that depends on the temperature characteristics (temperature change). These parameters are substituted into the formula (6) to give the trap level density N(Ea). The trap level density N(Ea) may also be expressed by the formula (7) below if it is represented as the function of activating energy Ea. Now, it is possible to obtain the trap level density N(Ea) in the I layer 22I and the I layer 32I (channel region) if the activating energy Ea is obtained by measuring the change in current that depends on the temperature characteristics (temperature change).

Activating energy Ea:

$$\frac{d I}{d V} = ξ exp ( - \frac{E}{kT} ) \qquad ( 1 )$$

Poisson equation:

$$\frac{{d}^{2} φ}{d {x}^{2}} = - \frac{ρ ( x )}{{ɛ}_{Si}} \qquad ( 2 )$$

Surface electric field:

$$\frac{d φ}{d x} {\vert}_{x = θ} = - \frac{{ɛ}_{0 x}}{{ɛ}_{Si}} \frac{{V}_{G} - {V}_{FB} - {φ}_{S}}{{d}_{0 x}} \qquad ( 3 )$$

Surface potential:

Eₐ=−E_{F}+E_{C}−qφs (4)

Charge in film:

$$ρ ( x ) = - q {\int }_{{E}_{F}}^{{E}_{F} + φ ( x )} {N}_{R} ( E ) d E \qquad ( 5 )$$

Trap level density:

$$\begin{matrix} N ( {E}_{a} ) = \frac{{ɛ}_{Si}}{2 q} \frac{{\partial }^{2}}{\partial φ {s}^{2}} {( \frac{d φ}{d x} {\vert}_{x = 0} )}^{2} & ( 6 ) \\ N ( {E}_{a} ) = \frac{\text{?}}{\text{?}} [ {\{ {q ( \frac{\partial {E}_{a}}{\partial \text{?}} )}^{- 1} \text{?} 1 \}}^{2} - {q}^{2} \frac{\partial \text{?}}{\partial \text{?}} ( \frac{\partial {E}_{a}}{\partial \text{?}} ) \text{?} \{ q ( \text{?} - \text{?} ) - ( \frac{\text{?}}{2} - \text{?} ) \} ] \\ \text{?} \text{indicates text missing or illegible when filed} & ( 7 )\end{matrix}$$

In the photodetecting element 3, the photoelectric current increases or decreases if the trap level density is low or high in the I layer 32I, respectively. This is reasoned as follows. In the I layer 32I of the photodetecting element 3, minority carriers (represented by “e” for electrons and “h” for holes) migrate by diffusion because there exists no strong electric field there as schematically shown in FIG. 3. Incidentally, the symbols “x” and the dotted lines in FIG. 3 denote respectively the crystal defect regions and the grain boundary of crystals in the I layer 32I. In this case, the equation of continuity is represented by the formula (8) below, and the boundary condition is represented by the formulas (9) and (10). These formulas lead to the formula (11). Also, the diffusion current at x=L is represented by the formula (12) below.

$$\begin{matrix}Dn ( \frac{d {n}_{p}}{d x} ) + {G}_{L} - ( {n}_{p} - {n}_{p 0} ) / τ = 0 & ( 8 ) \\ \{ \begin{matrix}{n}_{p} ( ∞ ) = {n}_{p 0} + {τ}_{n} {G}_{L} \\ {n}_{p} ( 0 ) = 0\end{matrix} & \begin{matrix}( 9 ) , ( 10 ) \\ \end{matrix} \\ {n}_{p} ( x ) = ( {n}_{p 0} + {τ}_{n} {G}_{L} ) \{ 1 - exp ( - x / {L}_{n} ) \} & ( 11 )\end{matrix}$$

(Lₙ: diffusion length)

$$\begin{matrix}Indiff = - q {D}_{n} {A}_{j} \frac{d {n}_{p}}{d x} \\ = {qD}_{n} {A}_{j} \{ ( {n}_{p 0} + τ {G}_{L} ) / {L}_{n} \} exp ( - L / {L}_{n} )\end{matrix} \qquad ( 12 )$$

The carrier life time τₙ, which is inversely proportional to the trap level density, is expressed by the formula (13) below. It is known from the formula (12) above that the photoelectric current is inversely proportional to the carrier life time τₙ. This means that an increase in the trap level density causes the carrier life time to decrease and consequently causes the photoelectric current to decrease. Meanwhile, the channel length (L length) for the photoelectric current to saturate becomes shorter according as the trap level density decreases (or according as the photoelectric current increases or the carrier life time τₙ increases), as shown in FIG. 4.

τₙ=1/(σₙνₜₕNₜ) (13)

σₙ: Capturing cross section

νₜₕ: Thermal velocity

Nₜ: Trap level density

In the case of the imaging device 1 according to the embodiment, the average trap level density (mentioned above) is no higher than 2.0×10¹⁷ (cm⁻³) in the I layer 22I of the TFT element 2 and in the I layer 32I (channel region) of the photodetecting element 3. (This will be discussed in detail later.) The result is that both the photodetecting element 3 and the TFT element 2 have high characteristic values (such as the amount of light detected and the ratio of on-off currents of transistor, respectively), as mentioned later.

The average trap level density in each of the I layer 22I and the I layer 32I should preferably be no higher than 1.2×10¹⁷ (cm⁻³) and no lower than 5.6×10¹⁶ (cm⁻³).

Production Method of the Imaging Device 1

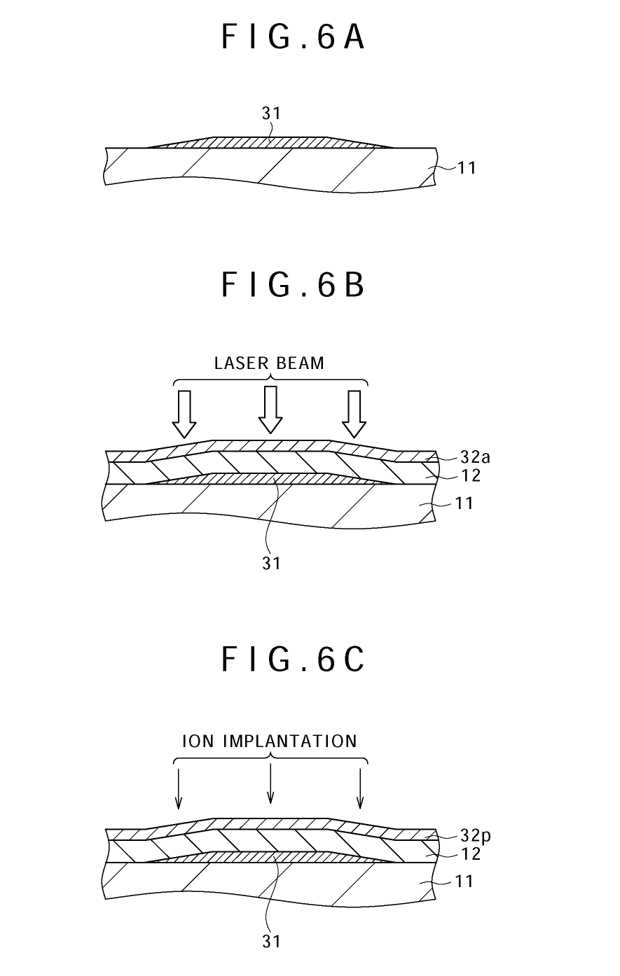

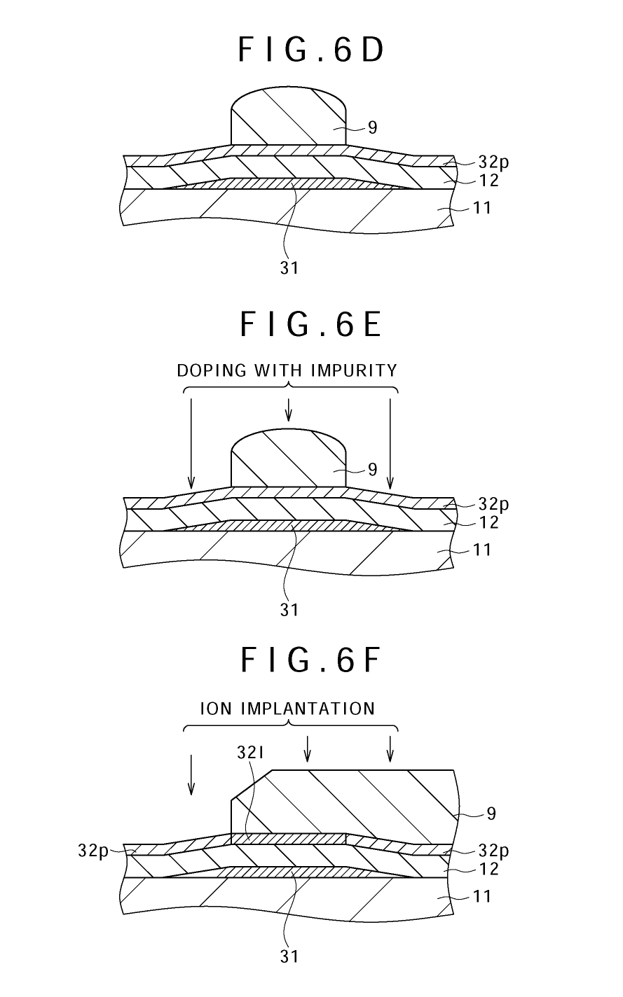

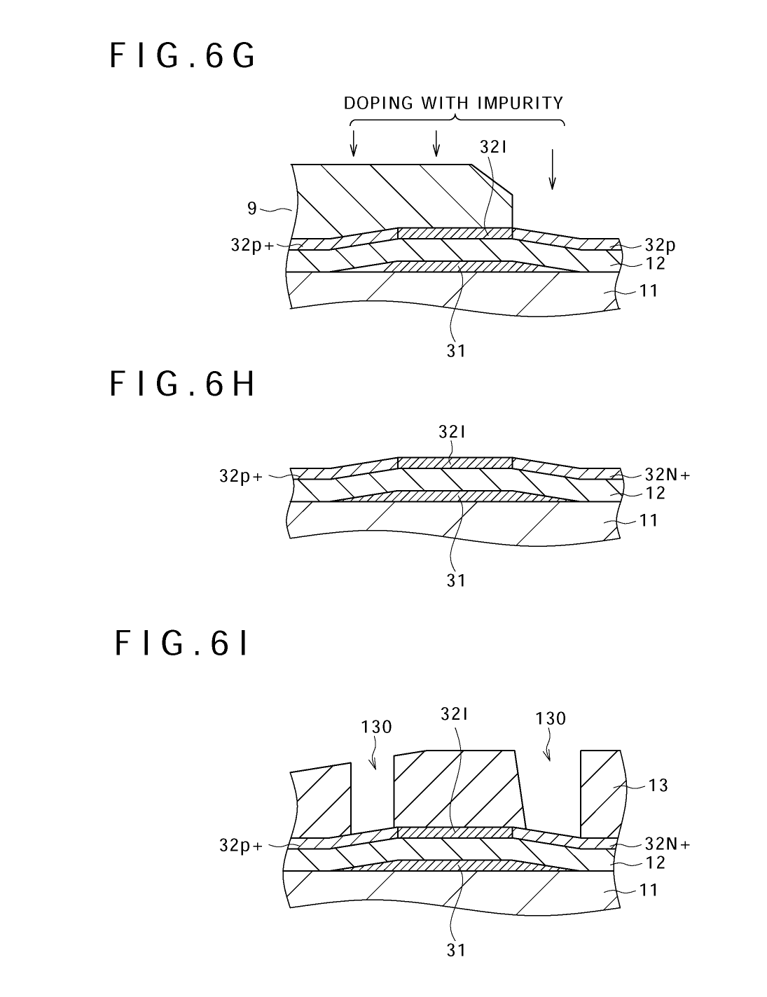

The imaging device 1 may be produced by the method which is described below with reference to FIGS. 5 to 6I. FIG. 5 is a flow chart showing the steps for production of the imaging device 1. FIGS. 6A to 6I are sectional views sequentially showing the individual steps for production. The following description and FIGS. 5 to 6I are concerned mainly with the method for forming the photodetecting element 3 of the imaging device 1. Here, it is assumed that the crystalline semiconductor is silicon (Si).

The first step, shown in FIG. 6A, starts with forming the gate electrodes 21 and 31 on the substrate 11 by sputtering or the like. (Step S11 in FIG. 5)

The gate electrodes 21 and 31 are coated sequentially with the gate insulating film 12 and the a-Si (amorphous silicon) layer 32a by CVD or the like. (Step S12) The thus formed gate insulating film 12 and a-Si layer 32a undergo dehydrogenation annealing. (Step S13)

The a-Si layer 32a undergoes laser annealing by irradiation with laser beams (such as excimer laser), as shown in FIG. 6B. This step performs recrystallization to form the p-Si (polysilicon) layer 32p. (Step S14)

The p-Si layer 32p undergoes ion implantation over its entire surface as shown in FIG. 6C. This step is intended to adjust the threshold value Vth. (Step S15)

The reverse side (opposite to the gate electrodes 21 and 31) of the substrate 11 is exposed to light. (Step S16) This exposure permits the resist film 9 to selectively remain in the regions where the I layers 22I and 32I are to be formed for the TFT element 2 and the photodetecting element 7, as shown in FIG. 6D.

The p-Si layer 32p undergoes uniform doping with an impurity so that the LDD layer 22L is formed, as shown in FIG. 6E. (Step S17) No impurity is doped in the region where the I layers 22I and 32I are to be formed because there selectively remains the resist film 9 there, as mentioned above. In this way the I layers 22I and 32I are formed.

The p-Si film 32p and the I layers 22I and 32I, which have the patterned resist film 9 remaining thereon, undergo impurity doping. In other words, selective impurity doping is performed on the region where the P+ layer 32P+ is to be formed. In this way there is formed the P+ layer 32P+ as shown in FIG. 6F. (Step S18)

The p-Si film 32p, the I layers 22I and 32I, and the P+ layer 32P+, which have the patterned resist film 9 remaining thereon, undergo impurity doping, as shown in FIG. 6G. In other words, selective impurity doping is performed on the region where the N+ layers 22N+ and 32N+ are to be formed. In this way there are formed the N+ layers 22N+ and 32N+ as shown in FIG. 6H. (Step S19)

The P+ layer 32P+, the N+ layers 22N+ and 32N+, and the I layers 22I and 32I, which have been formed as mentioned above, undergo annealing to activate the impurity. (Step S20) Then, the Si layer (semiconductor layer) undergoes element isolation. (Step S21) At the same time, the interlayer insulating film 13 is formed by CVD or the like. (Step S22)

The contact holes 130 are formed in those regions of the interlayer insulating film 13 where the source electrode 23S, the drain electrode 23D, the anode electrode 33A, and the cathode electrode 33C are to be formed, as shown in FIG. 6I. The contact holes are intended for electrical connection with these electrodes. (Step S23)

The contacts, wiring layers, and electrodes are formed by sputtering or the like. (Step S24) Then, the planarizing film 14 is formed by CVD or the like. (Step S25) In this way there is completed the imaging device 1 shown in FIG. 1.

Function and Effect of the Imaging Device 1

The imaging device 1 has the TFT element 2, which functions as a driving element for the photodetecting element 3 to accomplish photodetection (or light reception). The photodetecting element 3 works as follows. Upon receipt of incident light, the I layer 32I, which functions as an photodetector, generates photoelectric current in proportion to the amount of light received and the photoelectric current flows from the p+ layer 32P+ to the n+ layer 32N+. In this way, photodetection is accomplished.

Incidentally, the above-mentioned imaging device, which has the photodetecting element and its driving element formed on the same substrate, requires that both the photodetecting element and its driving element should have high characteristic values. However, the existing imaging device requires that the semiconductor layer (channel layer) of the photodiode (photodetecting element) should have a small film thickness so that leakage current is minimized while the TFT (driving element) is off. For this reason, the existing imaging device has the disadvantage that the incident light on the photodetecting element largely passes through the semiconductor layer (photoelectric conversion layer), which leads to insufficient photodetecting sensitivity (or small amount of light detected).

### Comparative Example 1

The imaging device pertaining to Comparative Example 1 (or the application in Patent Document 1 mentioned above) is constructed as follows. It has the substrate (with an underlying layer) on which is formed the first active layer (channel layer) that constitutes the driving element. On the same underlying layer as for the first active layer is also formed the second active layer that constitutes the photodetecting element in such a way that the second active layer has a higher photoabsorptivity than the first active layer. To be more specific, the second active layer in the photodetecting element is thicker than the first active layer in the driving element.

Unfortunately, the foregoing structure having the second active layer thinner than the first active layer needs complicated fabricating steps because these active layers (semiconductor layers) cannot be formed by the same step between the driving element and the photodetecting element.

### Comparative Example 2

By contrast, the imaging device pertaining to Comparative Example 2 (or the application in Patent Document 2 mentioned above) is constructed as follows. It has the PIN-type photodiode (photodetecting element) in which the intermediate semiconductor region is doped with a p-type impurity in low concentrations and a positive voltage is applied to the control electrode. This arrangement permits electron-hole pairs to separate as soon as they occur in the depletion layer in the intermediate semiconductor region, so that the photoelectric current is generated easily. The result is that the photoelectric current does not saturate even though the channel length (L length) is increased in the intermediate semiconductor region. This leads to an improvement in photodetecting sensitivity.

However, the technique used in Comparative Example 2 requires that the intermediate semiconductor region (channel region) of the photodetecting element should be doped with an impurity in higher concentrations than the channel region of the driving element. In other words, the photodetecting element and the driving element should differ from each other in impurity concentration in the channel layer (semiconductor layer). This necessitates additional steps, making the fabricating steps more complex.

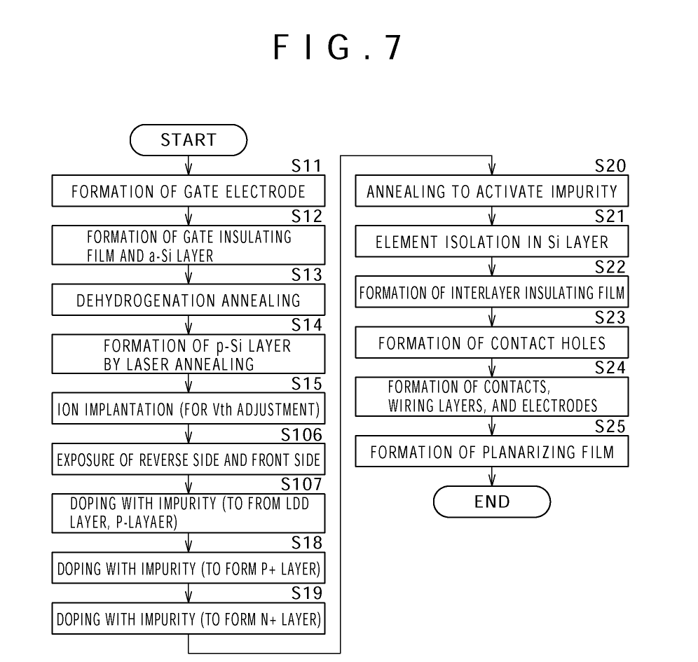

FIG. 7 is a flow chart showing the steps for production of the imaging device pertaining to Comparative Example 2. The flow chart shown in FIG. 7 (for the imaging device of Comparative Example 2) has the steps S106 and S107 in place of the steps S16 and S17 in the flow chart shown in FIG. 5 (for the imaging device of the embodiment), as explained below.

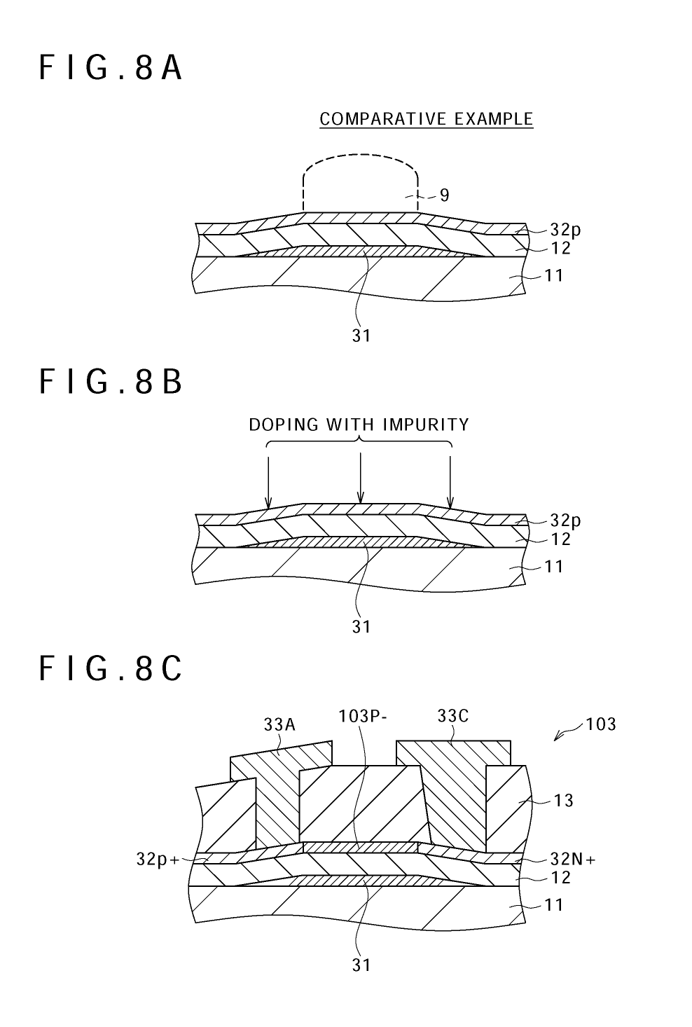

The step S106, which is included in the fabricating process for Comparative Example 2, differs from the step S16, which is included in the fabricating process for the embodiment, in that the substrate 11 undergoes exposure on its front side in addition to exposure on its reverse side. The front side is that side on which the gate electrodes 21 and 31 are formed. Consequently, Comparative Example 2 differs from the embodiment shown in FIG. 6D in that the photodetecting element has the resist film 9 removed. To be more specific, the resist film 9 is selectively left in the region where the I layer 22I is to be formed for the TFT element, whereas the resist film 9 is removed in the region where the P− layer 103P− (mentioned later) is to be formed for the photodetecting element 103 (mentioned later) pertaining to Comparative Example 2, as shown in FIG. 8A.

The step S107 for Comparative Example 2 is intended to perform uniform impurity doping on the a-Si layer 32p (shown in FIG. 8B) in the region where the photodetecting element 103 is to be formed, thereby forming the P− layer 103P−. In this way the channel region of the photodetecting element 103 is doped with an impurity in higher concentrations than the channel region of the TFT element 3.

The step S107 is followed by the steps S18 to S25 which are identical with those employed in the embodiment. Thus, as shown in FIG. 8C, there is completed the imaging device of Comparative Example 2 which has the photodetecting element 103.

The foregoing method for producing the imaging device 103 of Comparative Example 2 needs an additional step so that the channel layer (I layer 22I) of the TFT element 2 and the channel layer (P− layer 103P−) of the photodetecting element 103 differ from each other in impurity concentrations.

As mentioned above, the technique employed in Comparative Examples 1 and 2 involves difficulties in forming the photodetecting element and the driving element on the same substrate, both having high characteristic properties, without making the fabricating process more complex.

Functions Characteristic of the Embodiment

The embodiment differs from Comparative Examples mentioned above in that the channel region (I layer 32I) of the photodetecting element 3 and the channel region (I layer 22I) of the TFT element 2 are approximately equal to each other in their thickness and impurity concentration. This structure permits the two kinds of semiconductor layers (I layer and channel region) to be formed easily by the same step. In other words, there is no necessity of making the two kinds of semiconductor layers different from each other in thickness and impurity concentration as in Comparative Example 2 mentioned above.

In the imaging device 1 according to the embodiment, both the I layer 22I of the TFT element 2 and the I layer 32I (channel region) of the photodetecting element 3 have an average trap level density no higher than 2.0×10¹⁷ (cm⁻³). It follows, therefore, that both the photodetecting element 3 and the TFT element 2 have high characteristic values (such as the amount of light detected and the ratio of on-off currents in transistor, respectively). This will be discussed below with reference to Examples.

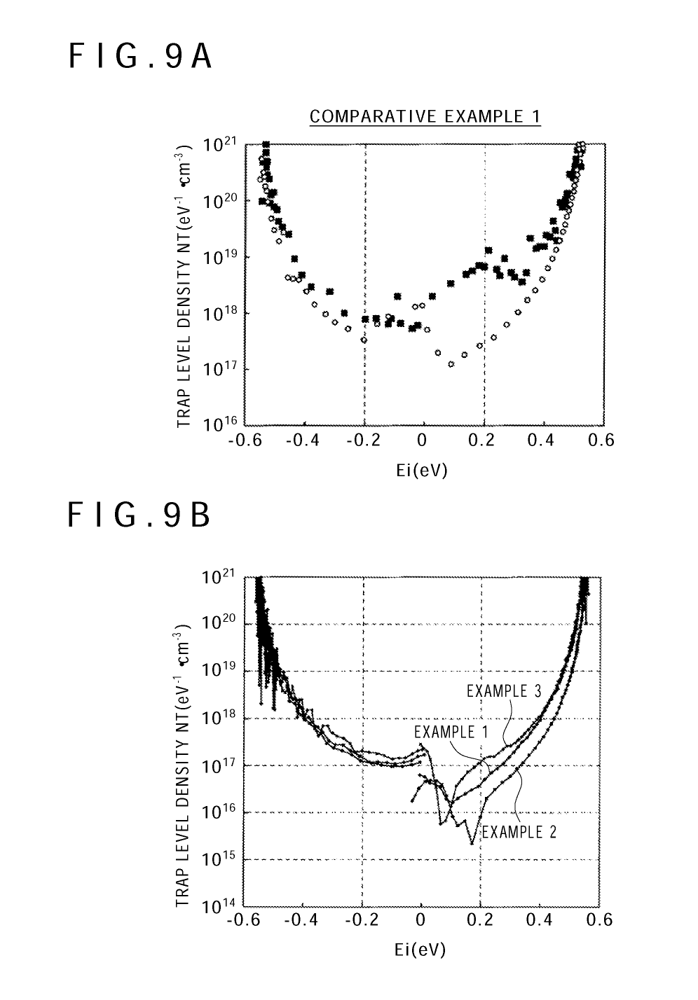

What is just mentioned above is illustrated in FIGS. 9A and 9B, the former showing the average trap level density in Comparative Example 1 and the latter showing the average trap level density in Examples 1 to 3 (or the embodiments). The average trap level density is an average of the trap level densities obtained by the FE method within the intrinsic Fermi level Ei±0.2 eV. It is noted that the average trap level density in Comparative Example 1, which is shown in FIG. 9A, is higher than that in Examples 1 to 3, which is shown in FIG. 9B. That is to say, the average trap level density in Comparative Example 1 is about 2.0×10¹⁸ (cm⁻³), whereas the average trap level density in Examples 1 to 3 is 7.8×10¹⁶ (cm⁻³), 5.6×10¹⁶ (cm⁻³), and 1.2×10¹⁷ (cm⁻³), respectively. In other words, the values in Examples 1 to 3 are no higher than 2.0×10¹⁷ (cm⁻³). Incidentally, the average trap level density in Comparative Example 2 (mentioned later) is 3.5×10¹⁸ (cm⁻³) (although not shown), which is also higher than the values in Examples 1 to 3.

Examples 1 to 3 and Comparative Examples 1 and 2 have such parameters as dose (amount of impurity) in channel region (semiconductor layer), film thickness, channel length (L length), fluence condition (conditions under which laser annealing is performed by excimer laser), and average trap level density, which are specified in the following. Incidentally, the desirable parameters for the embodiment are given below.

Dose: 3×10¹¹ to 8×10¹¹ (atm/cm²)

Film thickness: 30 to 60 (nm)

Channel length: 4 to 40 (μm)

Fluence condition: 510 to 580 (mJ)

### Example 1

Dose: 5×10¹¹ (atm/cm²)

Film thickness: 40 (nm)

Channel length: variable (mentioned later)

Fluence condition: 550 (mJ)

Average trap level density: 7.8×10¹⁶ (cm⁻³)

### Example 2

Dose: 3×10¹¹ (atm/cm²)

Film thickness: 60 (nm)

Channel length: variable (mentioned later)

Fluence condition: 580 (mJ)

Average trap level density: 5.6×10¹⁶ (cm⁻³)

### Example 3

Dose: 8×10¹¹ (atm/cm²)

Film thickness: 30 (nm)

Channel length: variable (mentioned later)

Fluence condition: 510 (mJ)

Average trap level density: 1.2×10¹⁷ (cm⁻³)

### Comparative Example 1

Dose: 1×10¹² (atm/cm²)

Film thickness: 40 (nm)

Channel length: variable (mentioned later)

Fluence condition: 510 (mJ)

Average trap level density: 2.0×10¹⁸ (cm⁻³)

### Comparative Example 2

Dose: 4×10¹² (atm/cm²)

Film thickness: 40 (nm)

Channel length: variable (mentioned later)

Fluence condition: 510 (mJ)

Average trap level density: 3.5×10¹⁸ (cm⁻³)

In order that the technique employed in Comparative Example 2 permits the electron-hole separation to take place in the film thickness direction, it seems necessary that the carrier density is higher than about 3×10¹⁷ (atm/cm²) and hence the dose is higher than about 4×10¹² (atm/cm²) as mentioned above. By contrast, the desirable dose is about 3×10¹¹ to 8×10¹¹ (atm/cm²) for the embodiment, as mentioned above. Consequently, the dose in the channel region is considerably lower in the embodiment than in Comparative Example 2.

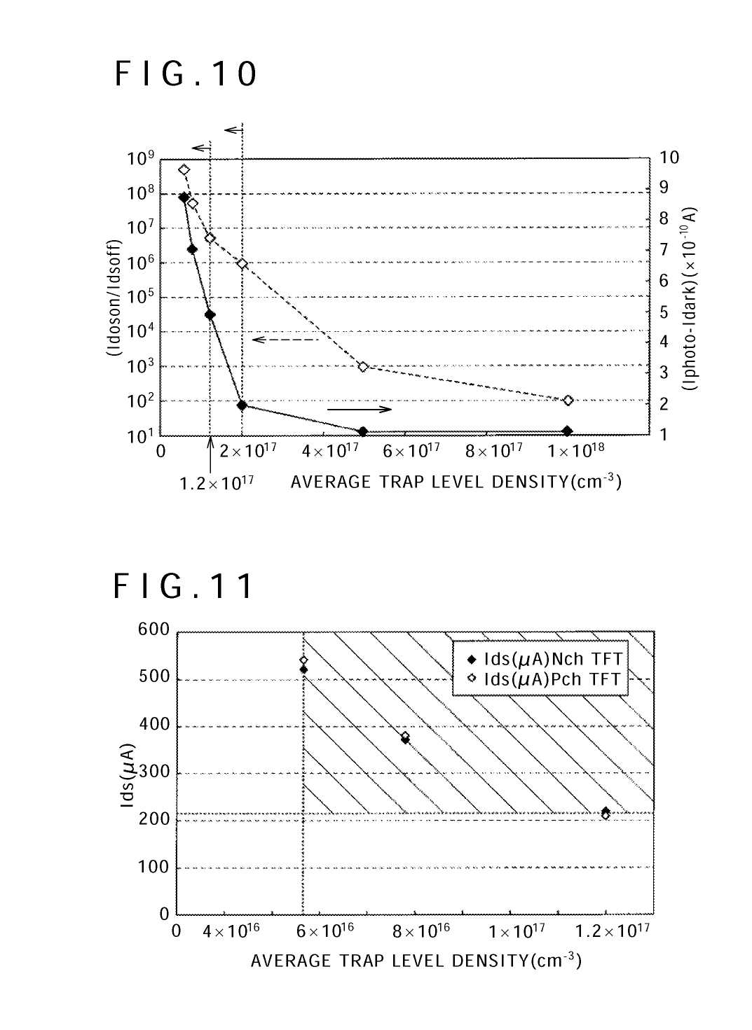

FIG. 10 is a graph showing the relation between the average trap level density and the characteristic properties of the TFT element 2 and the photodetecting element 3 in Example. One of the characteristic properties of the TFT element 2 is the ratio of on-off currents in the transistor, which is defined by I_{dson}/I_{dsoff}, where I_{dson} denotes current that flows across the source and drain when the transistor is turned on, and I_{dsoff} denotes current that flows across the source and drain when the transistor is turned off. One of the characteristic properties of the photodetecting element 3 is the amount of light detected, which is defined by Iₚₕₒₜₒ−I_{dark}, where Iₚₕₒₜₒ denotes photoelectric current and I_{dark} denotes dark current. The TFT element 2 has the channel width W and the channel length L in a ratio of 20 μm to 4.25 μm. The photodetecting element 3 has the channel width W and the channel length L in a ratio of 100 μm to 10 μm and is capable of detecting the wavelength of 850 nm.

It is noted from FIG. 10 that not only the photodetecting element 3 has the amount of light detected (Iₚₕₒₜₒ−I_{dark}) in high values but also the TFT element 2 has the ratio of on-off currents of transistor (I_{dson}/I_{dsoff}) in high values, if the I layer 22I and the I layer 32I (channel region) have an average trap level density no higher than 2.0×10¹⁷ (cm⁻³). In other words, when the average trap level density is no higher than 2.0×10¹⁷ (cm⁻³), the amount of light detected (Iₚₕₒₜₒ−I_{dark}) steeply increases and the ratio of on-off currents of transistor (I_{dson}/I_{dsoff}) also increases to high values necessary for satisfactory operation. FIG. 10 also suggests that the I layer 22I and the I layer 32I should preferably have an average trap level density no higher than 1.2×10¹⁷ (cm⁻³). This is because the average trap level density no higher than this value is important for a steep increase in the ratio on-off currents of transistor (I_{dson}/I_{dsoff}).

FIG. 11 is a graph showing the relation between the average trap level density and the characteristic property (source-drain current I_{ds}) of the TFT element 2 in Example.

The hatched area in FIG. 11 indicates the average trap level density and the source-drain current I_{ds} which are in the desirable range for the embodiment. To be more specific, the average trap level density in the I layer 22I and the I layer 32I should preferably be higher than 5.6×10¹⁶ (cm⁻³) which exceeds the upper limit mentioned above. Such high values are desirable for the semiconductor layer to be crystallized easily by laser annealing with excimer laser. Also, the source-drain current I_{ds} should preferably be higher than 210 (μA). Such high values are desirable for the TFT element 2 to have a small source-drain current I_{dsoff} (say, no higher than 1×10⁻¹⁰ A) that flows when it is turned off. This leads to adequate driving operation.

The imaging device 1 according to the embodiment should preferably have the photodetecting element in which the channel length (L length) of the I layer 32I is within the range given below.

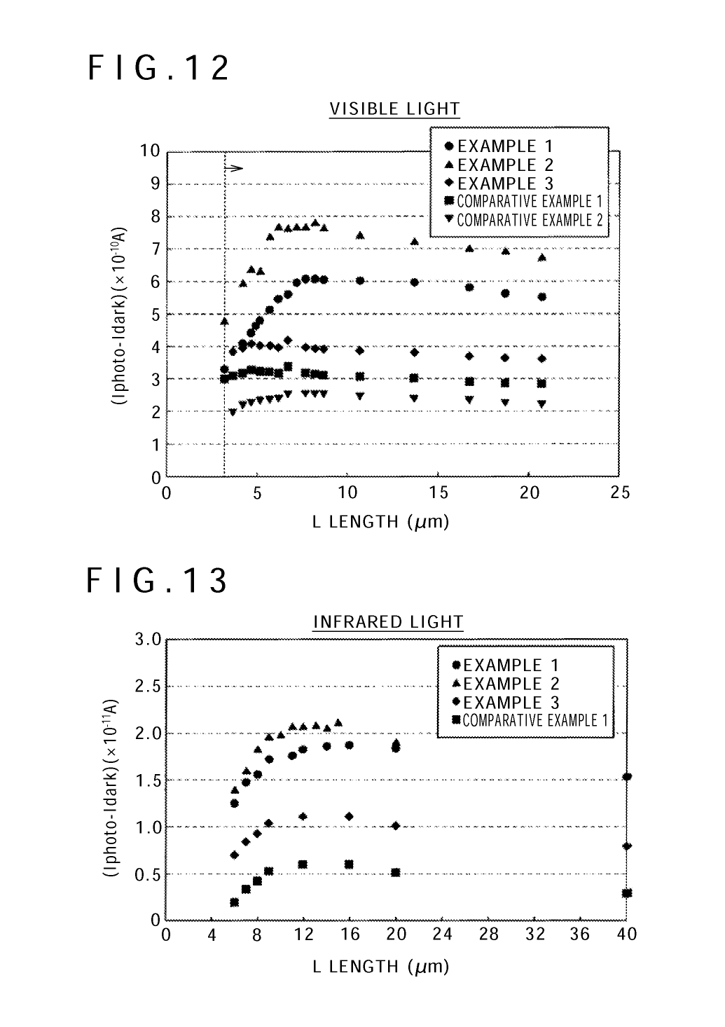

FIG. 12 is a graph showing the relation between the channel length L1 (L length) and the photodetecting characteristics (amount of light detected: Iₚₕₒₜₒ−I_{dark}) for visible light at a wavelength of 400 nm), the relation being observed in the photodetecting element pertaining to Examples 1 to 3 and Comparative Examples 1 and 2.

FIG. 12 suggests that the channel length L1 (L length) in the I layer 32I should preferably be larger than 4.0 μm according to the embodiment. The extended channel length increases the amount of light detected (Iₚₕₒₜₒ−I_{dark}) in Examples 1 to 3 than in Comparative Examples 1 and 2. According to the embodiment, the channel length L1 (L length) should preferably be a value ranging from 5 μm to 8 μm at which the (Iₚₕₒₜₒ−I_{dark}) becomes saturated or stabilized. The thus established channel length permits more stable photodetection than the channel length employed by the technique for Comparative Example 2 (which applies a positive voltage to the control electrode so that the photoelectric current linearly increases without saturation even when the channel length (L length) is increased). Incidentally, the technique for Comparative Example 2 causes the photoelectric current (the amount of light detected) to linearly increase in proportion to the channel length, and this causes individual photodetecting elements to fluctuate in characteristic properties according as the channel length varies.

It is noted from FIG. 12 that the amount of light detected (Iₚₕₒₜₒ−I_{dark}) is lower in the photodetecting element fabricated by the technique of Comparative Example 2 than in that according to Examples 1 to 3. A probable reason for this is that the density of crystal defects increases in proportion to the amount of impurities, which causes the photoelectric current to both increase and decrease, with the amount of light detected remaining not so high.

FIG. 13 is a graph showing the relation between the channel length L1 (L length) and the photodetecting characteristics (amount of light detected: Iₚₕₒₜₒ−I_{dark}) for infrared light at a wavelength of 850 nm), the relation being observed in the photodetecting element pertaining to Examples 1 to 3 and Comparative Examples 1 and 2. In this case, the photodetecting element 3 is capable of detecting infrared light.

Comparison between FIG. 12 and FIG. 13 indicates that the amount of light detected (Iₚₕₒₜₒ−I_{dark}) is larger for infrared light than for visible light. If it is assumed that A and B represent the amount of light detected in Example 3 and Comparative Example 2, respectively, then the ratio of A/B is about 4/3 for visible light whereas the ratio of A/B is about 2.0 for infrared light. In other words, the light receiving sensitivity for infrared light is twice as large as that for visible light.

As mentioned above, according to the embodiment, the photodetecting element 3 and the TFT element 2 have respectively the I layer 32I (channel region, semiconductor layer) and the I layer 22I (channel region, semiconductor layer) which are approximately equal to each other in thickness and impurity concentration. Moreover, both of these I layers 22I and 32I have an average trap level density no higher than 2.0×10¹⁷ (cm⁻³). The advantage of this structure is that the two kinds of the semiconductor layers (I layers 22I and 32I) can be formed easily by the same steps and that both the photodetecting element 3 and the TFT element 2 have high characteristic values. The foregoing demonstrates that the present application makes it possible to produce the photodetecting element 3 and the TFT element 2, both having high characteristic values, without relying on complicated steps.

### APPLICATION EXAMPLES

The above-mentioned imaging device 1 according to the embodiment will be applied to display-imaging devices and electronic machines and equipment as explained in the following.

Display-Imaging Device

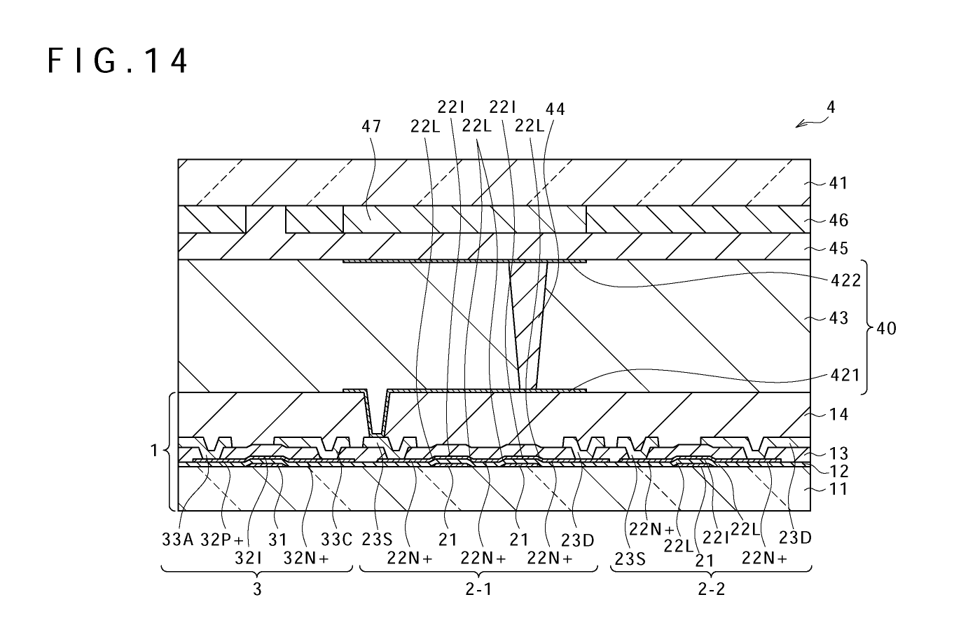

FIG. 14 is a schematic sectional view showing the structure of the liquid crystal display unit 4 as an example of the display-imaging device to which the imaging device 1 is applied. The liquid crystal display unit 4 includes the substrate 11, the gate insulating film 12, the interlayer insulating film 13, the planarizing film 14, the photodetecting elements 3, the TFT elements 2 (indicated by 2-1, 2-2, etc.), and the liquid crystal elements 40 (display elements). The liquid crystal element 40 includes the pixel electrode 421, the liquid crystal layer 43, and the common electrode 422. The liquid crystal display unit 4 includes the substrate 11 and the counter substrate 41 (transparent substrate) opposite thereto, on which are arranged the black matrix layer 46, the color filter 47, and the overcoat layer 45.

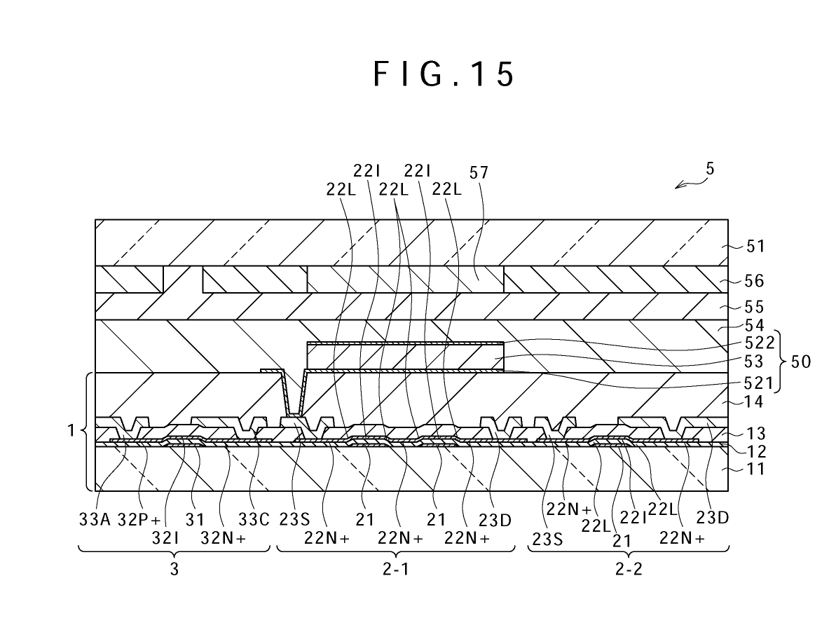

FIG. 15 is a schematic sectional view showing the structure of the organic EL (Electroluminescence) display unit 5 as an example of the display-imaging device to which the imaging device 1 is applied. The organic EL display unit 5 includes the substrate 11, the gate insulating film 12, the interlayer insulating film 13, the planarizing film 14, the resin layer 54, the photodetecting elements 3, the TFT elements 2 (indicated by 2-1, 2-2, etc.), and the organic EL elements 50 (display elements). The organic EL element 50 includes the anode electrode 521, the light-emitting layer 53 of organic material, and the cathode electrode 522. The organic EL display unit 5 includes the substrate 11 and the counter substrate 51 (transparent substrate) opposite thereto, on which are arranged the black matrix layer 56, the color filter 57, and the overcoat layer 55.

The display-imaging device constructed as mentioned above is capable of receiving ambient light from the surroundings and display light from the display element. Therefore, it will find use as a multifunctional display unit that controls the amount of light of display data and back light or that has the touch panel function, fingerprint input function, and scanning function.

Electronic Machines and Equipment

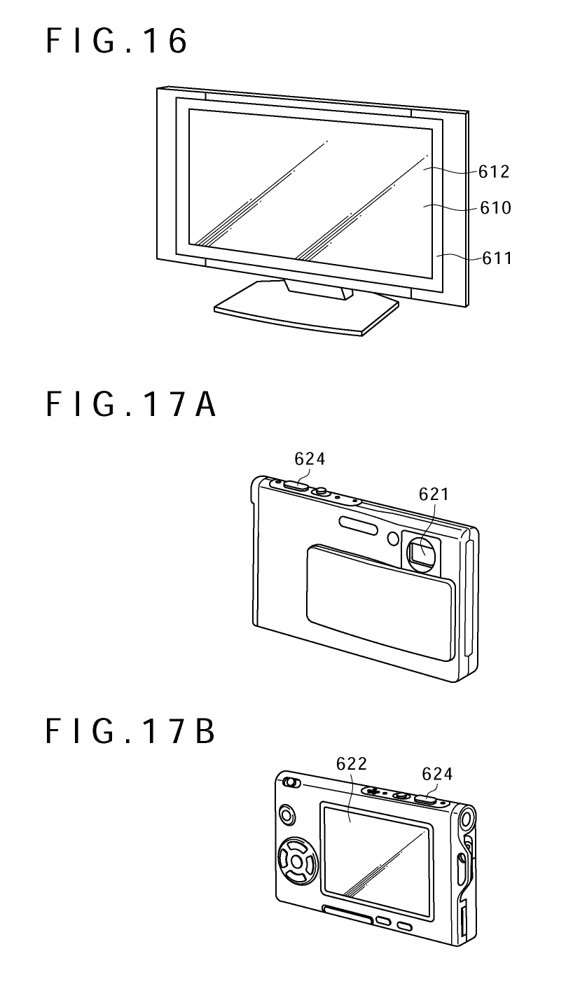

The display-imaging device mentioned above may also be applied to the electronic machines and equipment shown in FIGS. 16 to 20G, such as television set, digital camera, notebook personal computer, portable telephone (and similar portable terminals), and video camera. In other words, it may be applied to any kind of electronic machines and equipment which are intended to process video signals entered from the outside or generated in the inside, thereby displaying images (video) thereon.

### Application Example 1

FIG. 16 shows an external appearance of the television set to which the above-mentioned display-imaging device is applied. This television set includes the front panel 611, the filter glass 612, and the display image plane 610, and the last one includes the above-mentioned display-imaging device.

### Application Example 2

FIGS. 17A and 17B show external appearances of the digital camera to which the above-mentioned display-imaging device is applied. This digital camera has the flash 621, the display unit 622, the menu switch 623, and the shutter button 624, and the display unit 622 includes the above-mentioned display-imaging device.

### Application Example 3

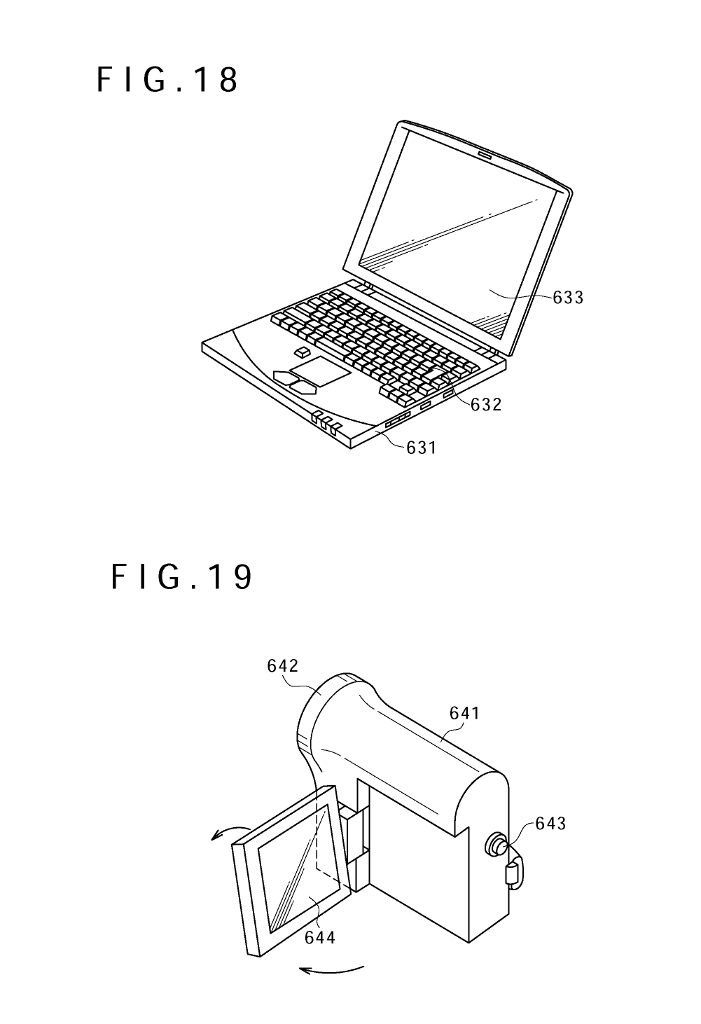

FIG. 18 shows an external appearance of the notebook personal computer to which the above-mentioned display-imaging device is applied. This notebook personal computer has the main body 631, the keyboard 632 for entry of letters, and the display unit 633. The last one includes the above-mentioned display-imaging device.

### Application Example 4

FIG. 19 shows an external appearance of the video camera to which the above-mentioned display-imaging device is applied. This video camera has the main body 641, the lens 642 for picture taking (which is attached to the front side of the main body 641), and the start/stop switch 643 for picture taking, and the display unit 644. The last one includes the above-mentioned display-imaging device.

### Application Example 5

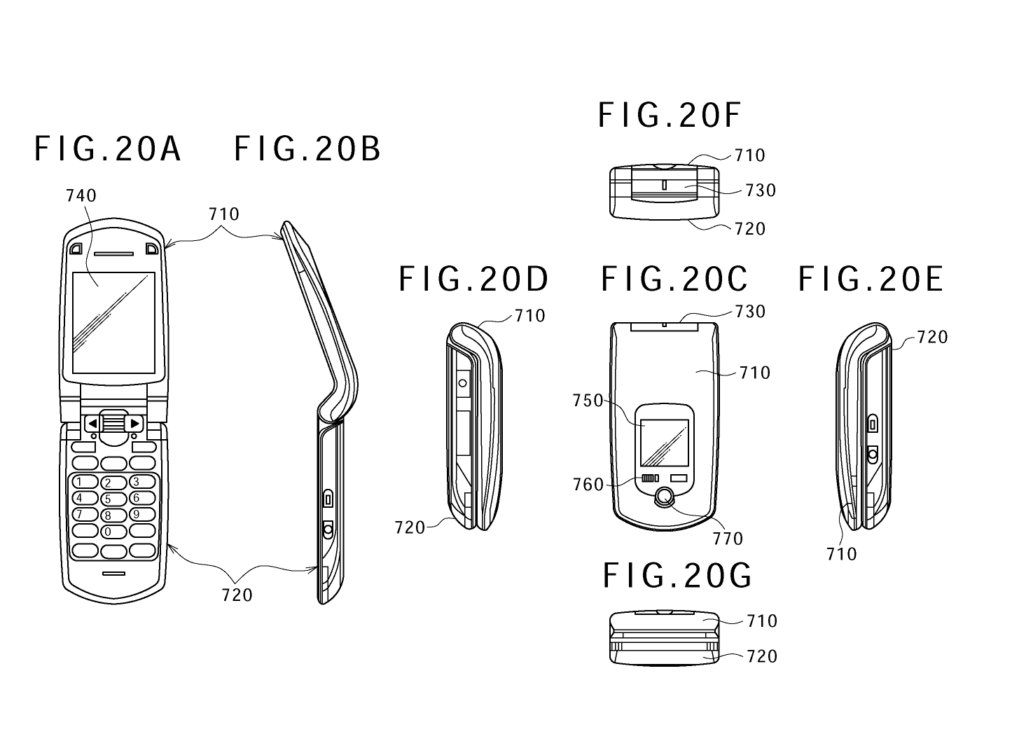

FIGS. 20A to 20G show external appearances of the portable telephone to which the above-mentioned display-imaging device is applied. This portable telephone includes the upper enclosure 710 and the lower enclosure 720 and the hinge 730 to join them together. It also has the display 740, the subdisplay 750, the picture light 760, and the camera 770. The first two include the above-mentioned display-imaging device.

### Modified Examples

Although the present application has been explained above with reference to embodiments and application examples, it may be variously modified without limitations imposed by them.

The above-mentioned embodiment covers the photodetecting element 3 which detects visible light and infrared light. However, the embodiment may be modified such that the photodetecting element 3 detects light in any other wavelength regions.

Although the above-mentioned embodiment employs a silicon thin film as the semiconductor layer, it may have the semiconductor layer formed from any other semiconductor such as silicon germanium (SiGe), germanium (Ge), selenium (Se), organic semiconductor, and oxide semiconductor.

It should be understood that various changes and modifications to the presently preferred embodiments described herein will be apparent to those skilled in the art. Such changes and modifications can be made without departing from the spirit and scope and without diminishing its intended advantages. It is therefore intended that such changes and modifications be covered by the appended claims.

The application is claimed as follows:

1. An imaging device comprising:
a plurality of photodetecting elements arranged on a substrate, each having a first semiconductor layer for the channel region; and
a plurality of driving elements arranged on said substrate, each having a second semiconductor layer for the channel region, wherein
said first and second semiconductor layers each are a crystallized semiconductor layer,
said first and second semiconductor layers each are approximately equal in thickness and impurity concentration, and
said first and second semiconductor layers each have an average trap level density no higher than 2.0×10¹⁷ cm⁻³ which is an average value of trap level density obtained by the Field Effect method within the range of intrinsic Fermi level Ei±0.2 eV.

2. The imaging device as defined in claim 1, wherein said first and second semiconductor layers have an average trap level density no higher than 1.2×10¹⁷ cm⁻³.

3. The imaging device as defined in claim 1, wherein said channel region in said first semiconductor layer has a channel length no smaller than 4.0 μm.

4. The imaging device as defined in claim 3, wherein said first and second semiconductor layers have an average trap level density no lower than 5.6×10¹⁶ cm⁻³.

5. The imaging device as defined in claim 1, wherein said photodetecting element is sensitive to infrared light.

6. The imaging device as defined in claim 1, wherein said photodetecting element is composed of PIN-type photodiodes and said driving element is composed of MOS-type thin-film transistors.

7. The imaging device as defined in claim 6, wherein said thin-film transistors are intended to drive said photodiode.

8. A display-imaging device comprising:
a plurality of display elements arranged on a substrate;
a plurality of photodetecting elements arranged on a substrate, each having a first semiconductor layer for the channel region; and
a plurality of driving elements arranged on said substrate, each having a second semiconductor layer for the channel region; wherein
said first and second semiconductor layers each are a crystallized semiconductor layer,
said first and second semiconductor layers each are approximately equal in thickness and impurity concentration, and
said first and second semiconductor layers each have an average trap level density no higher than 2.0×10¹⁷ cm⁻³ which is an average value of trap level density obtained by the Field Effect method within the range of intrinsic Fermi level Ei±0.2 eV.

9. An electronic equipment provided with
a display-imaging device, the display-imaging device comprising:
a plurality of display elements arranged on a substrate;
a plurality of photodetecting elements arranged on a substrate, each having a first semiconductor layer for the channel region; and
a plurality of driving elements arranged on said substrate, each having a second semiconductor layer for the channel region; wherein
said first and second semiconductor layers each are a crystallized semiconductor layer,
said first and second semiconductor layers each are approximately equal in thickness and impurity concentration, and
said first and second semiconductor layers each have an average trap level density no higher than 2.0×10¹⁷ cm⁻³ which is an average value of trap level density obtained by the Field Effect method within the range of intrinsic Fermi level Ei±0.2 eV.
